(19) United States
(12) Patent Application Publication
(10) Pub. No.: US 2019/0340517 A2
(43) Pub. Date: Nov. 7, 2019

(54) A METHOD FOR DETECTION AND CHARACTERIZATION OF TECHNICAL EMERGENCE AND ASSOCIATED METHODS

(71) Applicants: Olga Babko-Malaya, Winchester, MA (US); Daniel B. Hunter, Woburn, MA (US); Andrew C. Seidel, San Francisco, CA (US); Michelle A. Torrelli, Chelmsford, MA (US)

(72) Inventors: Olga Babko-Malaya, Winchester, MA (US); Daniel B. Hunter, Woburn, MA (US); Andrew C. Seidel, San Francisco, CA (US); Michelle A. Torrelli, Chelmsford, MA (US)

(73) Assignee: BAE Systems Information and Electronics Systems Integration Inc., Nashua, NH (US)

(21) Appl. No.: 15/035,555

(22) PCT Filed: Sep. 8, 2015
(86) PCT No.: PCT/US2015/048911

§ 371 Date: May 10, 2016

Related U.S. Application Data
(60) Provisional application No. 62/048,573, filed on Sep. 10, 2014.

(51) Int. Cl. G06N 5/02; G06F 17/30; G06N 7/00

(52) U.S. Cl. CPC G06N 5/022; G06N 7/005; G06F 17/3053; G06F 17/30011

(57) ABSTRACT

The present invention is a method for constructing a knowledgebase that can provide analysis and trend prediction of emerging technologies. Metadata and full text are gathered from collections of documents, which can include more than 10 million documents, and are used to build a heterogeneous network of elements related to themes such as technical emergence. Indicators and models are selected that identify network characteristics and trends of interest. The indicators can be derived by applying a combination of citation analyses, natural language processing, entity disambiguation, organization classification, and time series analyses. A metric can be used to evaluate indicator utility. A framework can be sued to generate and validate the indicators. The models can be derived using an automated process. Upon receipt of a query, the indicators and models can be used to apply a scoring process to extracted features to predict a future prominence of an entity.

### RELATED APPLICATIONS

This application claims the benefit of U.S. Provisional Application No. 62/048,573, filed Sep. 10, 2014, which is herein incorporated by reference in its entirety for all purposes.

### STATEMENT OF GOVERNMENT INTEREST

This invention was made with United States Government support under Contract No. D11PC20154 awarded by the United States Department of the Interior. The United States Government has certain rights in this invention.

### FIELD OF THE INVENTION

The present invention relates to the processing of data, and more particularly to analysis of scientific and patent literature metadata and text for assessing technical emergence.

### BACKGROUND OF THE INVENTION

The ability to predict emergence of new ideas, trends, and topics has broad implications for many different stakeholders, including scientists deciding which subjects of research to pursue, government agencies deciding which programs to support, companies choosing where resources should be focused, investors selecting which technologies to fund, and intelligence analysts monitoring where the most interesting technologies are being developed.

Predictions of this nature are generally made by “experts” and other analysts having skill and knowledge in various fields, based on their review of available data, including publically available documents such as patents and technical papers. However, predictions made in this way can be inherently unreliable, due to gaps in the knowledge of such analysts, limits to the quantity of information that an analyst can reasonably review, and any predispositions that an analyst may have based on individual experience and interests.

Once a trend or topic of interest has been identified, automated tools are available that can be used to search for relevant information. The prior art discloses a number of methods for analyzing documents, including patents as well as technical and/or scientific literature, so as to retrieve information regarding topics/technologies of interest.

U.S. Pat. No. 6,151,600, for example, teaches that information may be appraised electronically. According to this approach, electronic data is stored on a data server, requests for information are sent to this data server based on search criteria, and matching results are returned. This system also includes a metering server that enables the retrieval of data from the electronic database.

In another approach, U.S. Pat. No. 7,668,885 teaches that data may be compiled into a computer-based adaptive knowledge system for immediate use in analysis. The knowledge system is created by modifying, individualizing, and prioritizing a database according to third-party metadata, personality, and preference characterization. The system thereby compiles data of interest to the user, categorizes the data, and organizes the data into selectable infrastructures.

However, these methods are limited to locating patents or other documents that match specified search criteria that is input by a user. This requires that the user must have already determined by some other means what trend, topic or technology area is of interest, before documents and other information relating to that trend, topic, or technology area can be sought and located.

Other methods attempt to identify trends and topics of interest by applying citation analysis to a database of compiled documents, for example by analyzing papers and researchers based on citation frequency, patterns, and graphs of citations. However, these tools are limited to citations, and cannot extract and summarize information discussed in the full text of the documents themselves.

Accordingly, there is a need for an improved method for achieving a complete characterization of a knowledge base, including full text data as well as citations and metadata, so as to enable automatic identification of emerging technologies and other trends and topics that may be candidates for further research and monitoring.

### SUMMARY OF THE INVENTION

The present invention is a method for achieving a complete characterization of a knowledge base, including full text data as well as citations and metadata, so as to enable automatic identification of emerging technologies and other trends, and topics that may be candidates for further research and monitoring. In various embodiments, the disclosed method is able to distil information from very large databases, and is customizable to various tasks, including prediction of emerging scientific topics and technologies.

Specifically, the present invention is a method for creating a knowledge base based on metadata and full text extracted and distilled from collections of data, whereby the method comprises the steps of using said data to build a heterogeneous network of elements related to emerging technologies and other trends, and selecting indicators and models to identify network characteristics and trends of interest to users, whereby information regarding emerging technologies and trends may be distilled from said data.

In embodiments, information is gathered, including metadata and full text, from collections of scientific articles and patents. In various embodiments, tens of millions of documents can be processed. The extracted information is then used to build a heterogeneous network of elements related to an analysis of technical emergence. Indicators and models are then selected to identify network characteristics and trends that are of interest to users. In embodiments, a framework is employed for generation and validation of a large number of indicators. These indicators are derived by combining citation analyses, natural language processing, entity disambiguation, organization classification, and time series analyses. Embodiments of the invention employ an automated process for model selection and training, as well as various metrics for evaluating the utility of indicators. These evaluations can include making predictions about new scientific topics and technologies relative to mature topics that have significant histories.

The present invention enables the extraction of data from full text as well as by citation analysis. Furthermore, the method of the present invention includes a framework that allows it to easily adapt to different user needs, and to various domains of application such as medical, defense, and others. As a result, the present invention is customizable to the data set, and may be used for a variety of applications. In particular, it should be noted that, while many of the examples and explanations given herein are directed to detecting the emergence of technical trends and new technologies, the disclosed method is not limited only to technological fields, but is also applicable to the detection of emerging trends and topics of interest in law, politics, fashion, entertainment, art, literature, and many other fields of interest.

The present invention is a method for constructing a knowledgebase that is useful for providing analysis and predictions based on a collection of data. The method includes obtaining a collection of data, extracting features from said data, at least one of said features being extracted from full text included in said data, applying disambiguation to said extracted features, using said collection of data and extracted features to build a heterogeneous network of elements related to at least one designated theme, and deriving indicators and models from said network of elements that identify network characteristics and trends characteristic of said collection of data, wherein said collection of data, extracted features, heterogeneous network of elements, indicators, and models are configured as a knowledgebase that is suitable for providing analysis and predictions based on the collection of data.

In embodiments, the collection of data includes a plurality of documents. In some of these embodiments, the documents in the collection of data are obtained from at least one of a document repository and a document superset. In other of these embodiments, the documents include patents and papers. In still other of these embodiments, the documents are represented in an extensible markup language (XML) format. In yet other of these embodiments, the collection of data includes at least ten million documents.

In any of the preceding embodiments, deriving said indicators can include at least one of citation analysis, natural language processing, entity disambiguation, organization classification, and time series analysis.

In any of the preceding embodiments, deriving said indicators can include application of a combination of citation analyses, natural language processing, entity disambiguation, organization classification, and time series analyses to said network of elements.

In any of the preceding embodiments, deriving said indicators can include using a framework to generate and validate the indicators.

In any of the preceding embodiments, n at least some of the models can be derived using an automated process.

In any of the preceding embodiments, at least some of the models can be derived using at least one metric for evaluating a utility at least one of the indicators.

In any of the preceding embodiments, the at least one designated theme can include technical emergence.

In any of the preceding embodiments, said features can include at least one of topics, funding, organizations in text, relationships between citations, relationships between technical terms, document sections, and document genre.

Any of the preceding embodiments can further include accepting a nomination query from a user, extracting features from said knowledgebase based on said query, using said indicators and models to apply a scoring process to said extracted features to predict a future prominence of at least one entity related to said query, and providing said prediction to said user. And in some of these embodiments the extracted features include properties of elements in the heterogeneous network relating to at least one of terminology, patent impact, paper impact, persons, and organizations. Other of these embodiments further include g providing an explanation of said prediction to said user. Still other of these embodiments further include after applying said scoring process, delivering feedback to the knowledgebase and using said feedback to improve future predictions of prominence of entities.

In any of the preceding embodiments identify network characteristics and trends can include deriving indicators from at least one of metadata and full text included in the collection of data, and using Bayesian models to combine the indicators.

And, in any of the preceding embodiments, the indicators can be derived by applying computations that include at least one of a time series and a single value.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a diagram that illustrates a flow and transformation of information according to an embodiment of the present invention;

FIG. 2 is a diagram that illustrates actions that occurs within a knowledge base in an embodiment of the present invention; and

FIG. 3 is a flow diagram that illustrates a fragment of a model for predicting term prominence in an embodiment of the present invention.

### DETAILED DESCRIPTION

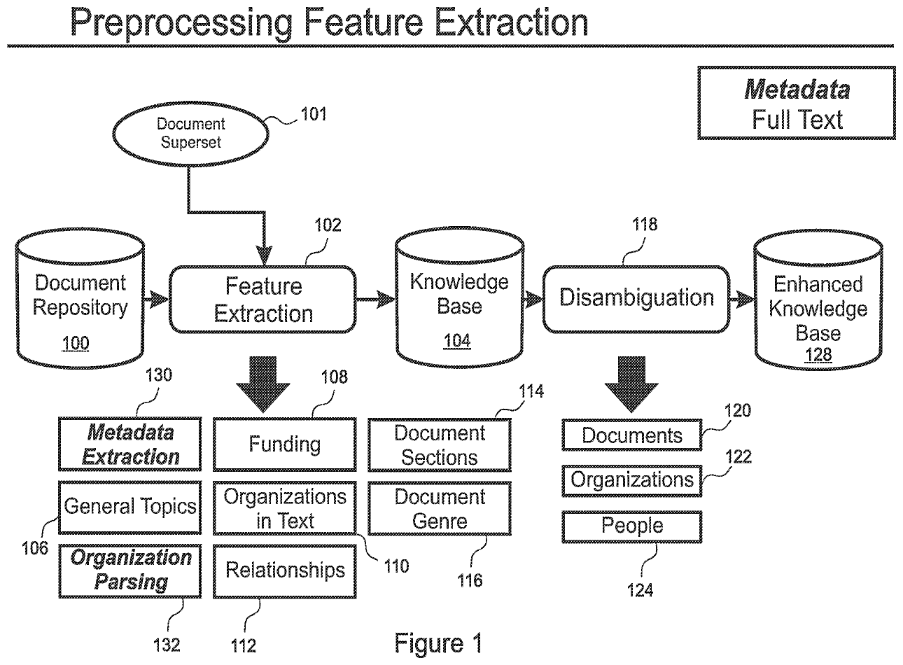

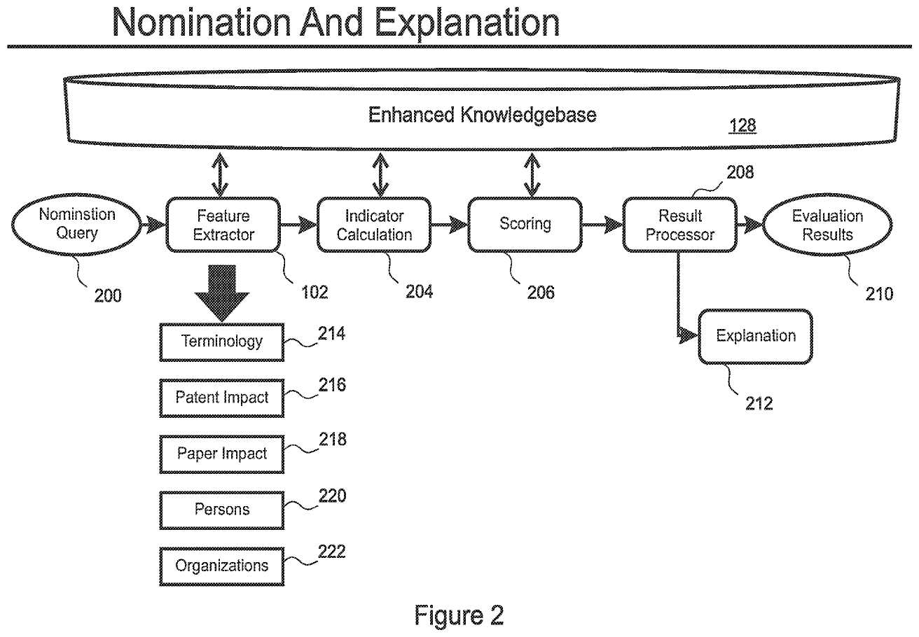

The present invention can be better understood with reference to the accompanying drawings. In particular, FIGS. 1 and 2 illustrate information flow in an embodiment. In both of FIGS. 1 and 2, standing information databases are indicated by cylinders. In embodiments, these standing information databases are documents represented in the extensible markup language (XML) format. In the illustrated embodiment, the standing information databases are scientific documents which store data in a simple form for further processing.

In both figures, external items entering or leaving the otherwise closed system are indicated by oval shapes. These represent, for example, queries entered into the system and answers returned from the system.

In both figures, steps performed by system components are indicated by rounded rectangles. These steps can include the extraction of information from the data compilation, such as relationships recognized during compilation of the data.

Finally, in both figures features extracted from the data for use in data analysis are represented by rectangles with sharp corners appearing at the bottoms of the diagrams. Most notably, the bold labels in rectangles 130 132 in FIG. 1 indicate that the information is pulled from the metadata of the full text.

FIG. 1 is a diagram that illustrates the flow and transformation of information in an embodiment of the present invention. In the figure, data from any document superset 101 and/or document repository 100, including full text and metadata, flows into a knowledge base 104 via a feature extraction component 102, which extracts features from the full text and metadata and exposes data themes such as topics 106, funding 108, text organizations 110, relationships between citations and technical terminology 112, document sections 114, and document genres 116.

The extracted feature information is then distilled via disambiguation 118 of documents 120, organizations 122, and people 124, and used to build a heterogeneous network of elements related to designated themes such as technical emergence. The result is an “enhanced” knowledgebase 128 containing an improved data analysis.

FIG. 2 is a diagram that illustrates steps of an embodiment of the present method wherein the enhanced knowledge base 128 is used to provide an analysis and/or make predictions in response to a user query. When a nomination query is input 200, the feature extractor 102 identifies the features relevant to the query that are contained within the enhanced knowledgebase 128, and examines those features to determine the properties of the terms 214; impact of documents (such as patents 216 and papers 218), persons 220, and organizations 222 in the heterogeneous network of elements; and the relationships therebetween. Then an indicator calculation 204 is applied to the extracted features to derive information relevant to predicting the future prominence of entities within the network.

Next, a scoring process 206 uses trained models to predict future prominence of entities. Following each of these three components 202, 204, 206 of the process, feedback is delivered to the knowledgebase 128 for better analysis concerning later inquiries. After scoring 206, the result process 208 provides results (predictions of prominence) that are available for evaluation 210 together with explanations 212 of the predictions.

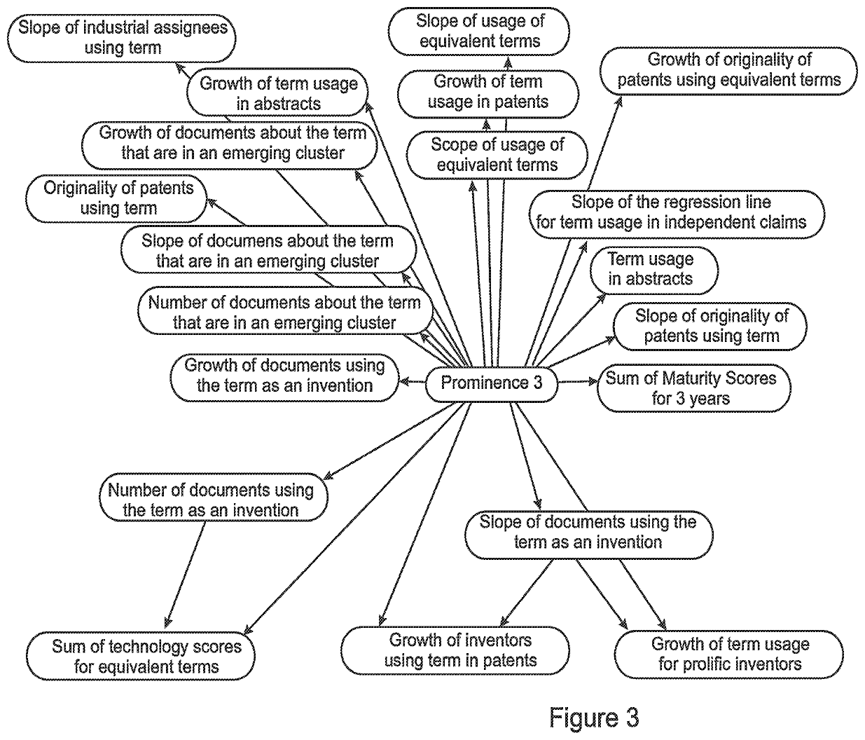

FIG. 3 is a flow diagram that illustrates a fragment of a model for predicting term prominence in an embodiment of the present invention. In embodiments, the models are tree-augmented Naive Bayes networks (ref: Friedman N, Geiger D., Goldszmidt M. 1997. Bayesian Networks Classifiers. Machine Learning, 29, 131-163). In some of these embodiments, the models are trained to forecast future term prominence, where a term is considered prominent if it has achieved a significant increase in usage.

In embodiments, forecasting of prominence is accomplished by entering indicator values into the Bayes net and doing standard Bayesian updating. This results in an estimate of the probability that the term will be prominent at a specified future time called the “forecast period.” Prominence is here defined in terms of the predicted increase in usage of the term. If the increase in usage exceeds a specified threshold, the term is said to be prominent in the forecast period. The indicators can measure relationships between scientific terms with other elements in the network, including the extent and nature of related elements, their novelty and dynamic changes, as well as their impact, prominence and diversity. In embodiments, other indicators relate technology emergence to practicality, and/or the presence of a debate in a community.

In various embodiments, indicators are generated by applying time series and/or single values, as illustrated by the following.

Time series:

annual counts: e.g. number of prominent inventors per year using term in patents

annual scores: e.g. mean citation index, generality

Single value:

Counts: e.g. number of prior art references, number of co-authors, number of academic patent assignees

Score/average score: e.g. maturity score, originality, generality, mean citation index

Novelty: e.g. the year the term first appeared

Regarding the time series indicators, in some embodiments the modeling process is simplified by reducing each time series to a single value. In some of these embodiments, any or all of four different methods are applied:

Slope—finding the slope of the regression line of indicator value on year (a measure of how fast the indicator is increasing over time);

Growth—calculating the average growth rate for the indicator value over the period selected for the time series;

Sum—computing the sum of indicator values for 3 years prior to the reference period.

Geo Mean—computing the geometric mean of indicator values for five years prior to the reference period

The scoring process 206 outputs a probability that the input term will achieve prominence during the forecast period. The result process 208 uses this probability to determine a categorical “Prominent/not-Prominent” decision as to whether the term will become prominent. The decision “Prominent” is output if the model's probability of prominence exceeds a specified threshold. This threshold is a parameter that is chosen automatically during model training so as to optimize the trade-off between various measures of predictive accuracy.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application.

This specification is not intended to be exhaustive. Although the present application is shown in a limited number of forms, the scope of the invention is not limited to just these forms, but is amenable to various changes and modifications without departing from the spirit thereof. One or ordinary skill in the art should appreciate after learning the teachings related to the claimed subject matter contained in the foregoing description that many modifications and variations are possible in light of this disclosure. Accordingly, the claimed subject matter includes any combination of the above-described elements in all possible variations thereof, unless otherwise indicated herein or otherwise clearly contradicted by context. In particular, the limitations presented in dependent claims below can be combined with their corresponding independent claims in any number and in any order without departing from the scope of this disclosure, unless the dependent claims are logically incompatible with each other.

I claim:

1. A method for constructing a knowledgebase useful for providing analysis and predictions based on a collection of data, the method comprising:
obtaining a collection of data;
extracting features from said data, at least one of said features being extracted from full text included in said data;
applying disambiguation to said extracted features;
using said collection of data and extracted features to build a heterogeneous network of elements related to at least one designated theme; and
deriving indicators and models from said network of elements that identify network characteristics and trends characteristic of said collection of data,
wherein said collection of data, extracted features, heterogeneous network of elements, indicators, and models are configured as a knowledgebase that is suitable for providing analysis and predictions based on the collection of data.

2. The method of claim 1, wherein said collection of data includes a plurality of documents.

3. The method of claim 2, wherein the documents in the collection of data are obtained from at least one of a document repository and a document superset.

4. The method of claim 2, wherein said documents include patents and papers.

5. The method of claim 2, wherein the documents are represented in an extensible markup language (XML) format.

6. The method of claim 2, wherein the collection of data includes at least ten million documents.

7. The method of claim 1, wherein deriving said indicators includes at least one of citation analysis, natural language processing, entity disambiguation, organization classification, and time series analysis.

8. The method of claim 1, wherein deriving said indicators includes application of a combination of citation analyses, natural language processing, entity disambiguation, organization classification, and time series analyses to said network of elements.

9. The method of claim 1, wherein deriving said indicators includes using a framework to generate and validate the indicators.

10. The method of claim 1, wherein at least some of the models are derived using an automated process.

11. The method of claim 1, wherein at least some of the models are derived using at least one metric for evaluating a utility at least one of the indicators.

12. The method of claim 1, wherein the at least one designated theme includes technical emergence.

13. The method of claim 1, wherein said features include at least one of:
topics;
funding;
organizations in text;
relationships between citations;
relationships between technical terms;
document sections; and
document genre.

14. The method of claim 1, further comprising:
accepting a nomination query from a user;
extracting features from said knowledgebase based on said query;
using said indicators and models to apply a scoring process to said extracted features to predict a future prominence of at least one entity related to said query; and
providing said prediction to said user.

15. The method of claim 14, wherein said extracted features include properties of elements in the heterogeneous network relating to at least one of:
terminology;
patent impact;
paper impact;
persons; and
organizations.

16. The method of claim 14, further comprising providing an explanation of said prediction to said user.

17. The method of claim 14, further comprising, after applying said scoring process, delivering feedback to the knowledgebase and using said feedback to improve future predictions of prominence of entities.

18. The method of claim 1, wherein identify network characteristics and trends includes:
deriving indicators from at least one of metadata and full text included in the collection of data; and
using Bayesian models to combine the indicators.

19. The method of claim 1, wherein the indicators are derived by applying computations that include at least one of a time series and a single value.
